(19) United States
(12) Patent Application Publication
(10) Pub. No.: US 2006/0231597 A1
(43) Pub. Date: Oct. 19, 2006

(54) Method for joining a tube to a member using deformation resistance welding/brazing

(75) Inventors: Venkatasubramanian Ananthanarayanan, Beavercreek, OH (US); Essam E. Salama, West Chester, OH (US); Michael W. Hurtt, Waynesville, OH (US); Steven P. Donahue, Fairborn, OH (US)

Correspondence Address: Delphi Technologies, Inc.;Legal Staff - M/C 480-410-202, P.O. Box 5052, Troy, MI, 48007-5052, US

(73) Assignee: Delphi Technologies, Inc.

(21) Appl. No.: 11/370,427

(22) Filed: Mar. 8, 2006

Related U.S. Application Data
(60) Provisional application No. 60/671,116, filed on Apr. 13, 2005.

(51) Int. Cl. B23K 31/02; B23K 1/20; B21D 39/00

(52) U.S. Cl. 228/173.4; 228/171

(57) ABSTRACT

One method for joining a tube to a member includes obtaining a tube and obtaining a member having a surface groove. The tube is relatively positioned with respect to the member to completely cover the surface groove without the tube entering the surface groove, wherein the tube is in direct contact with the member and/or is in indirect contact with the member through an intervening joining material. A resistance welding/brazing current path is created through the tube and the member creating a weld/braze zone which includes at least some of the tube and at least some of the member and which fills in at least some of the surface groove. During the resistance welding/brazing path creation, a force is applied to relatively move the tube deformingly against the member. Another method describes the tube having the surface groove which is to be completely covered by the member.

### CROSS REFERENCE TO RELATED APPLICATIONS

The present application claims priority of U.S. Provisional Application No. 60/671,116 filed Apr. 13, 2005.

### TECHNICAL FIELD

The present invention relates generally to attaching parts together, and more particularly to a method for joining a tube to a member using deformation resistance welding/brazing.

### BACKGROUND OF THE INVENTION

Conventional methods for attaching parts together, such as a vehicle damper (shock absorber) base cup to a mounting bracket, include gas metal arc welding. Gas metal arc welding uses a consumable metal wire as one electrode and the parts as another electrode, and moves the consumable metal filler wire (or the parts) to draw an arc and weld the parts together. The welding is accompanied by a gas (such as a mixture of argon and carbon dioxide) which acts as shielding to prevent oxidation and stabilize the arc. Such gas metal arc welding consumes a considerable amount of filler wire, shielding and power and is well known.

Resistance welding (also known as electric-resistance welding) is a known metallurgical process wherein metal is heated by its own resistance to a semi-fused (i.e., soft) or fused (i.e., molten) state by the passage of very heavy electric currents for very short lengths of time and then welded by the application of pressure.

Conventional resistance seam welding is a known welding process. In a known vehicle application, a damper tube or damper dust cover is resistance seam welded to a steel plate by using two welding electrode wheels which rotate as the tube/cover rotates to form the seam weld. The steel plate is then bolted to a cast iron damper mounting ring with an intervening rubber seal.

What is needed is an improved method for joining a tube to a member using deformation resistance welding/brazing.

### SUMMARY OF THE INVENTION

A broad first method of the invention is for joining a tube to a member and includes steps a) through e). Step a) includes obtaining a tube. Step b) includes obtaining a member having a surface groove. Step c) includes, after steps a) and b), relatively positioning the tube with respect to the member to completely cover the surface groove of the member without the tube entering the surface groove, wherein the tube is in at least one of a direct contact with the member and an indirect contact with the member through an intervening joining material. Step d) includes, after step c), creating a resistance welding/brazing current path through the tube and the member creating a weld/braze zone which includes at least some of the tube and at least some of the member and which fills in at least some of the surface groove. Step e) includes, during step d), applying a force to relatively move the tube deformingly against the member.

A broad second method of the invention is for joining a tube to a member and includes steps a) through e). Step a) includes obtaining a tube having a surface groove. Step b) includes obtaining a member. Step c) includes, after steps a) and b), relatively positioning the member with respect to the tube to completely cover the surface groove of the tube without the member entering the surface groove, wherein the member is in at least one of a direct contact with the tube and an indirect contact with the tube through an intervening joining material. Step d) includes, after step c), creating a resistance welding/brazing current path through the tube and the member creating a weld/braze zone which includes at least some of the tube and at least some of the member and which fills in at least some of the surface groove. Step e) includes, during step d), applying a force to relatively move the tube deformingly against the member.

Several benefits and advantages are derived from at least one of the broad methods of the invention. In a first example of the broad first method, a single piece cast iron damper base cup and mounting bracket is deformation-resistance-welded/brazed to a folded or non-folded end flange of a steel vehicle damper tube wherein the weld/braze zone includes the (longitudinally facing) surface groove creating a strong bond. The first example provides a durable, high pressure, hermetic weld/braze joint between the cast iron member and the steel tube. In a second example of the broad first method, the cast iron circular plate portion of a damper mounting bracket is placed inside a steel vehicle damper dust cover or damper tube and electrode wheels are used to create a resistance seam weld/braze zone wherein the weld/braze zone includes the (circumferentially outwardly facing) surface groove creating a strong bond. Likewise, the second example provides a durable, high pressure, hermetic weld/braze joint between the cast iron member and the steel tube. It is noted that resistance welding is less expensive than gas metal arc welding. The metallurgical bond in this case between parts welded can be engineered to be either a solid-state bond or a melted and solidified nugget. Dissimilar materials, like cast iron and steel, can be joined to each other with solid-state bonds.

### SUMMARY OF THE DRAWINGS

FIG. 1 is a block diagram of the broad first method of the invention for joining a tube to a member using deformation resistance welding/brazing;

FIG. 2 is a schematic, side cross-sectional view of a damper tube starting to be deformation-resistance-welded to a base cup portion of a member which also includes a mounting bracket, wherein the base cup has a circumferential surface groove longitudinally facing an outwardly-extending, non-folded end flange of the damper tube; and

FIG. 3 is a schematic, side cross-sectional view of a portion of a tube (which is a damper dust cover or a damper tube) being deformation-resistance-welded to a circular plate of a mounting bracket wherein the circular plate of the mounting bracket is disposed inside the damper dust cover/damper tube and has a radially-outwardly-facing circumferential surface groove.

### DESCRIPTION OF THE PREFERRED EMBODIMENTS

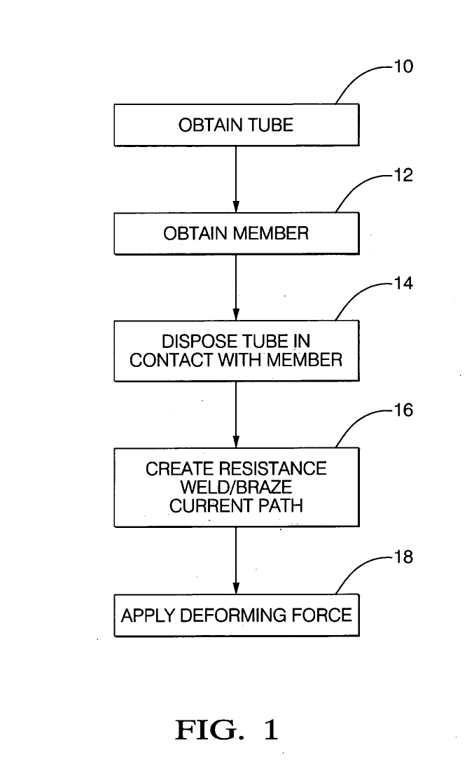

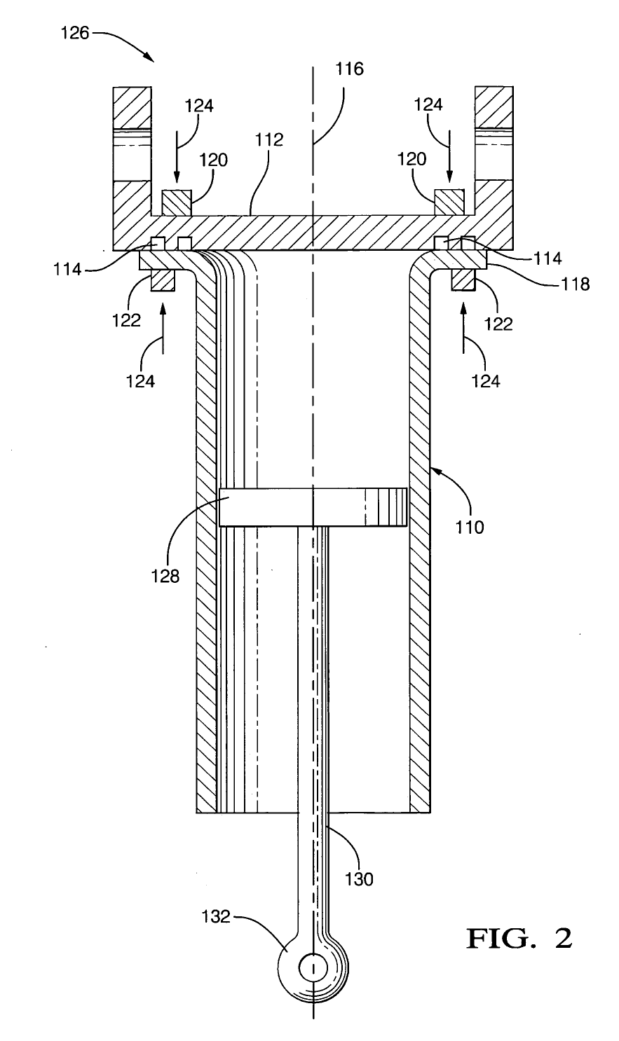

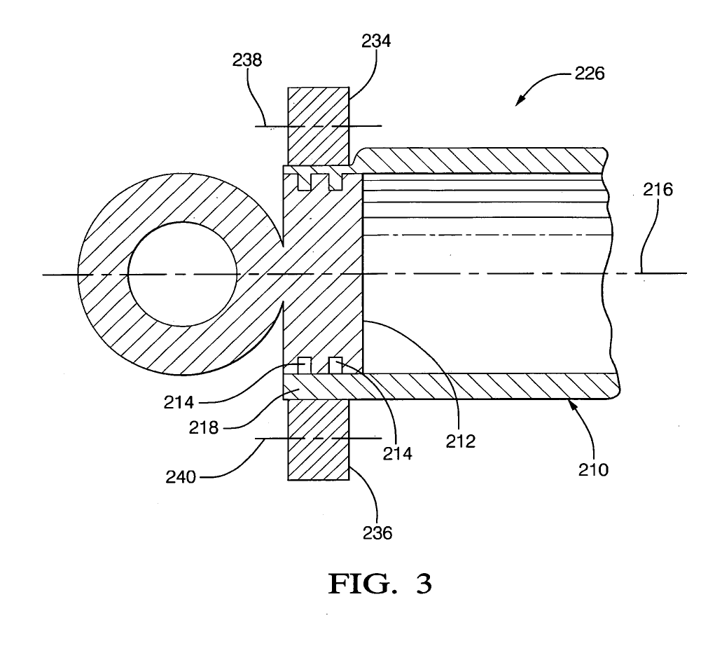

A broad first method of the invention is shown in FIG. 1 with first and second embodiments thereof shown in FIGS. 2 and 3. The broad first method is for joining a tube 110 or 210 to a member 112 or 212 and includes steps a) through e). Step a) is labeled as “Obtain Tube” in block 10 of FIG. 1. Step a) includes obtaining a tube 110 or 210. Step b) is labeled as “Obtain Member” in block 12 of FIG. 1. Step b) includes obtaining a member 112 or 212 having a surface groove 114 or 214. Step c) is labeled as “Dispose Tube In Contact With Member” in block 14 of FIG. 1. Step c) includes, after steps a) and b), relatively disposing the tube 110 or 210 with respect to the member 112 or 212 to completely cover the surface groove 114 or 214 of the member 112 or 212 without the tube 110 or 210 entering the surface groove 114 or 214, wherein the tube 110 or 210 is in at least one of a direct contact with the member 112 or 212 and an indirect contact with the member 112 or 212 through an intervening joining material (not shown). Step d) is labeled as “Create Resistance Weld/Braze Current Path” in block 16 of FIG. 1. Step d) includes, after step c), creating a resistance welding/brazing current path through the tube 110 or 210 and the member 112 or 212 creating a weld/braze zone which includes at least some of the tube 110 or 210 and at least some of the member 112 or 212 and which fills in at least some of the surface groove 114 or 214. Step e) is labeled as “Apply Deforming Force” in block 18 of FIG. 1. Step e) includes, during step d), applying a force to relatively move the tube 110 or 210 deformingly against the member 112 or 212.

The terminology “weld/braze” includes weld or braze or both weld and braze. The terminology “relatively disposing the tube with respect to the member to completely cover the surface groove” includes disposing the tube or the member or both the tube and the member to completely cover the surface groove. The terminology “to relatively move the tube deformingly against the member” includes moving the tube against the member causing deformation, moving the member against the tube causing deformation, and moving both the tube and the member against each other causing deformation.

In a first embodiment of the broad first method, as shown in FIG. 2, the tube 110 has a longitudinal axis 116 and a transversely-extending flange 118. In this embodiment, step c) relatively disposes the tube 110 with respect to the member 112 with the flange 118 completely covering the surface groove 114 of the member 112 and with the surface groove 114 of the member 112 facing in a direction which is substantially parallel to the longitudinal axis 116. In this embodiment, the flange 118 is in at least one of a direct contact with the member 112 and an indirect contact with the member 112 through an intervening joining material (not shown), and the member 112 is a non-tubular member.

In one configuration of the first embodiment, the surface groove 114 has a transversely innermost extent (closest to the longitudinal axis 116) and a transversely outermost extent (furthest from the longitudinal axis 116), and the flange 118 transversely extends from before the transversely innermost extent of the surface groove 114 to beyond the transversely outermost extent of the surface groove 114. In one variation, the surface groove 114 is an annular groove substantially coaxially aligned with the longitudinal axis 116. In one modification, the surface groove 114 has a substantially rectangular cross section.

In one arrangement of the first embodiment, step e) applies a force to relatively longitudinally move the flange 118 deformingly against the member 112 (such as, in one example, by applying force against welding/brazing electrodes 120 and 122 along the direction of arrows 124 in FIG. 2). In one variation, the flange 118 is in direct contact with the member 112. In a different variation, the flange 118 is in indirect contact with the member 112, and the joining material is chosen from the group consisting of a weld-filler joining material and a braze joining material.

In one application of the first embodiment, the flange 118 is an end flange. In another application, not shown, the flange is not an end flange. In one variation of either application, the flange 118 is a radially-outwardly-projecting flange. In another variation, not shown, the flange is a radially-inwardly-projecting flange. In one modification of either application, the flange 118 is a non-folded flange. In another modification, not shown, the flange is a folded flange.

In a second embodiment of the broad first method, as shown in FIG. 3, the tube 210 has a longitudinal axis 216 and a tube end portion 218. In this embodiment, step c) relatively disposes the tube 210 with respect to the member 212 with the tube end portion 218 circumferentially surrounding and completely covering the surface groove 214 of the member 212 and with the surface groove 214 of the member 212 facing in a radially outward direction from the longitudinal axis 216. In this embodiment, the tube end portion 218 is in at least one of a direct contact with the member 212 and an indirect contact with the member 212 through an intervening joining material (not shown), and the member 212 is a non-tubular member.

In one configuration of the second embodiment, the surface groove 214 has a longitudinally innermost extent (closest to the midpoint of the tube's length) and a longitudinally outermost extent (closest to the tube's end), and the tube end portion 218 longitudinally extends from before the longitudinally innermost extent of the surface groove 214 to beyond the longitudinally outermost extent of the surface groove 214. In one variation, the surface groove 214 is an annular groove substantially coaxially aligned with the longitudinal axis 216. In one modification, the surface groove 214 has a substantially rectangular cross section.

In one arrangement of the second embodiment, step e) applies a force to relatively radially move the tube end portion 218 deformingly against the member 212. In one variation, the tube end portion 218 is in direct contact with the member 212. In a different variation, the tube end portion 218 is in indirect contact with the member 212, and the joining material is chosen from the group consisting of a weld-filler joining material and a braze joining material.

In one example of the second embodiment, step c) includes disposing the member 212 at least partially inside the tube end portion 218 of the tube 210. In the same or a different example, the surface groove 214 is a partial or complete circumferential groove and step d) includes using, as seen in FIG. 3, two welding/brazing electrode wheels 234 and 236 having an axis of rotation 238 and 240 creating a continuous or non-continuous circumferential seam weld/braze zone. It is noted that electrode wheel 234 is shown applying a deformation force while electrode wheel 236 is shown, for illustrative purposes only, before applying a deformation force. In practice, both electrode wheels 234 and 236 would act together in applying opposing deformation forces.

In a third embodiment of the broad first method, not shown, the tube has a longitudinal axis and a tube end portion. In this embodiment, step c) disposes the tube with the tube end portion circumferentially surrounded by and completely covered by the surface groove of the member and with the surface groove of the member facing in a radially inward direction toward the longitudinal axis.

A more-detailed first method of the invention is for joining a tube 110 or 210 to a member 112 or 212 and includes steps a) through e). Step a) includes obtaining a tube 110 or 210. Step b) includes obtaining a member 112 or 212 having a surface groove 114 or 214. Step c) includes, after steps a) and b), relatively disposing the tube 110 or 210 with respect to the member 112 or 212 to completely cover the surface groove 114 or 214 of the member 112 or 212 without the tube 110 or 210 entering the surface groove 114 or 214, wherein the tube 110 or 210 is in at least one of a direct contact with the member 112 or 212 and an indirect contact with the member 112 or 212 through an intervening joining material (not shown). Step d) includes, after step c), creating a resistance welding/brazing current path through the tube 110 or 210 and the member 112 or 212 creating a weld/braze zone which includes at least some of the tube 110 or 210 and at least some of the member 112 or 212 and which fills in at least some of the surface groove 114 or 214. Step e) includes, during step d), applying a force to relatively move the tube 110 or 210 deformingly against the member 112 or 212. In the more detailed first method of the invention, the tube 110 or 210 is chosen from the group consisting of a damper tube of a vehicle damper 126 or 226 and a dust cover of a vehicle damper 126 or 226, and the member 112 or 212 is chosen from the group consisting of a damper mounting bracket of a vehicle damper 126 or 226 and a monolithic damper base cup and mounting bracket of a vehicle damper 126 or 226.

In one modification of the more-detailed first method, the surface groove 114 or 214 has a substantially rectangular cross section. It is noted that the other embodiments, configurations, arrangements, etc. of the broad first method are equally applicable to the more-detailed first method.

In one example of the more-detailed first method, the tube 110 is a damper tube of a vehicle damper 126, and the member 112, which includes a circular surface groove 114 (two surface grooves 114 are shown in FIG. 2), is a monolithic damper base cup and mounting bracket. In this example, the vehicle damper 126 also includes a piston 128 slidingly disposed in the tube 110, a piston rod 130 attached to the piston 128, and a mounting ring 132 attached to the free end of the piston rod 130. In one employment of the vehicle damper 126, one of the member 112 and the mounting ring 132 is attached to the vehicle frame (not shown), and the other of the member 112 and the mounting ring 132 is attached to a vehicle suspension system component (not shown). In one choice of materials, the member 112 consists essentially of a low carbon steel, and the tube 110 consists essentially of steel or a dissimilar material. It is noted that the surface groove 114 is especially helpful in achieving a strong leak-tight bond when joining dissimilar materials as the groove facilitates relative motion of the weld/braze interface resulting in a bond that is not brittle.

In a different example of the more-detailed first method, the tube 210 is a damper dust cover or damper tube of a vehicle damper 226 (only a portion of which is shown in FIG. 3), and the member 212, which includes a complete circumferential surface groove 214 (two surface grooves 214 are shown in FIG. 3), is a damper mounting bracket which is placed inside and welded/brazed (such as being solid-state continuous-seam welded) to the tube end portion 218. In one employment of the vehicle damper 226, the damper mounting bracket is attached to the vehicle frame or a vehicle suspension system component (not shown). In one choice of materials, the member 212 consists essentially of cast iron, and the tube 210 consists essentially of steel or a dissimilar material. It is noted that the surface groove 214 is especially helpful in achieving a strong airtight or leak-fight bond when joining dissimilar materials as the groove facilitates relative motion of the weld/braze interface resulting in a bond that is not brittle.

A broad second method of the invention, not shown in the figures, is similar to the previously-described broad first method except that the tube, instead of the member, is described as having the surface groove. Thus, the broad second method is for joining a tube to a member and includes steps a) through e). Step a) includes obtaining a tube having a surface groove. Step b) includes obtaining a member. Step c) includes, after steps a) and b), relatively disposing the member with respect to the tube to completely cover the surface groove of the tube without the member entering the surface groove, wherein the member is in at least one of a direct contact with the tube and an indirect contact with the tube through an intervening joining material. Step d) includes, after step c), creating a resistance welding/brazing current path through the tube and the member creating a weld/braze zone which includes at least some of the tube and at least some of the member and which fills in at least some of the surface groove. Step e) includes, during step d), applying a force to relatively move the tube deformingly against the member.

In one embodiment of the broad second method, the member is a non-tubular member. In one modification, the surface groove has a substantially rectangular cross section. It is noted that the other embodiments, configurations, arrangements, etc. of the broad first method, and the identification of the tube and the member with vehicle damper components of the more-detailed first method, are equally applicable to the broad second method with suitable adjustments being made for the tube now being described as having the surface groove.

In any one or more or all of the above described methods, it is noted that the member is not limited to one surface groove in the broad first and/or more-detailed first method and that the tube is not limited to one surface groove in the broad second method. Also, that the member is described as having a surface groove does not prevent the tube from also having a surface groove and vice versa. In one variation, only the thicker one of the tube and the member has any surface groove. In one illustration, the surface groove is a closed-path groove such as, without limitation, a longitudinally-facing circular surface groove or a radially outwardly or inwardly facing circumferential surface groove. In another illustration, the surface groove is not a closed-path groove. In one variation, the tube and/or member has a plurality of closed-path and/or non-closed-path surface grooves. In one employment, step d) creates a weld/braze zone which fills in substantially all of the surface groove. In one choice of materials, the portions of the tube and the member to be welded/brazed together consist essentially of similar materials. In another choice of materials, the portions of the tube and the member to be welded/brazed together consist essentially of dissimilar materials.

In one example of one or both of the above described broad methods, the member is a tubular member. In another example, the member is a non-tubular member. In one variation, the member is a plate (with or without a through hole). In one modification, the member is a monolithic plate portion of a damper mounting ring. In one variation, the monolithic plate portion acts as a damper base cup. In one construction, the damper mounting ring consists essentially of cast iron, and the tube is a damper dust cover or a damper tube consisting essentially of steel. In one design, the tube is a substantially circular tube. In another design, the tube has a substantially rectangular, square, or other cross-sectional shape.

In one implementation of any one or more or all of the above described methods, step c) is performed without the use of an intervening weld-filler or braze joining material. In another implementation, step c) is performed with the use of an intervening weld-filler or braze joining material. In one application, step d) creates a weld zone. In one variation, the weld zone of step d) was created from at least some molten material of the tube and/or member. In another variation the weld zone of step d) was created from at least some non-molten material (i.e., solid-state welding) of the tube and/or member. In a different application, step d) creates a braze zone. Other implementations, applications and variations are left to the artisan.

Several benefits and advantages are derived from at least one of the broad methods of the invention. In a first example of the broad first method, a single piece cast iron damper base cup and mounting bracket is deformation-resistance-welded/brazed to a folded or non-folded end flange of a steel vehicle damper tube wherein the weld/braze zone includes the (longitudinally facing) surface groove creating a strong bond. The first example provides a durable, high pressure, hermetic weld/braze joint between the cast iron member and the steel tube. In a second example of the broad first method, the cast iron circular plate portion of a damper mounting bracket is placed inside a steel vehicle damper dust cover or damper tube and electrode wheels are used to create a resistance seam weld/braze zone wherein the weld/braze zone includes the (circumferentially outwardly facing) surface groove creating a strong bond. Likewise, the second example provides a durable, high pressure, hermetic weld/braze joint between the cast iron member and the steel tube. It is noted that resistance welding is less expensive than gas metal arc welding. The metallurgical bond in this case between parts welded can be engineered to be either a solid-state bond or a melted and solidified nugget. Dissimilar materials, like cast iron and steel, can be joined to each other with solid-state bonds.

The foregoing description of several methods of the invention has been presented for purposes of illustration. It is not intended to be exhaustive or to limit the invention to the precise procedures or precise forms disclosed, and obviously many modifications and variations are possible in light of the above teaching. It is intended that the scope of the invention be defined by the claims appended hereto.

1. A method for joining a tube to a member comprising the steps of:
a) obtaining a tube;
b) obtaining a member having a surface groove;
c) after steps a) and b), relatively disposing the tube with respect to the member to completely cover the surface groove of the member without the tube entering the surface groove, wherein the tube is in at least one of a direct contact with the member and an indirect contact with the member through an intervening joining material;
d) after step c), creating a resistance welding/brazing current path through the tube and the member creating a weld/braze zone which includes at least some of the tube and at least some of the member and which fills in at least some of the surface groove; and
e) during step d), applying a force to relatively move the tube deformingly against the member.

2. The method of claim 1, wherein the tube has a longitudinal axis and a transversely-extending flange, and wherein step c) relatively disposes the tube with respect to the member with the flange completely covering the surface groove of the member and with the surface groove of the member facing in a direction which is substantially parallel to the longitudinal axis, wherein the flange is in at least one of a direct contact with the member and an indirect contact with the member through an intervening joining material, and wherein the member is a non-tubular member.

3. The method of claim 2, wherein the surface groove has a transversely innermost extent and a transversely outermost extent, and wherein the flange transversely extends from before the transversely innermost extent of the surface groove to beyond the transversely outermost extent of the surface groove.

4. The method of claim 3, wherein the surface groove is an annular groove substantially coaxially aligned with the longitudinal axis.

5. The method of claim 4, wherein step e) applies a force to relatively longitudinally move the flange deformingly against the member.

6. The method of claim 5, wherein the flange is in direct contact with the member.

7. The method of claim 5, wherein the flange is in indirect contact with the member, and wherein the joining material is chosen from the group consisting of a weld-filler joining material and a braze joining material.

8. The method of claim 5, wherein the surface groove has a substantially rectangular cross section.

9. The method of claim 1, wherein the tube has a longitudinal axis and a tube end portion portion, and wherein step c) relatively disposes the tube with respect to the member with the tube end portion circumferentially surrounding and completely covering the surface groove of the member and with the surface groove of the member facing in a radially outward direction from the longitudinal axis, wherein the tube end portion is in at least one of a direct contact with the member and an indirect contact with the member through an intervening joining material, and wherein the member is a non-tubular member.

10. The method of claim 9, wherein the surface groove has a longitudinally innermost extent and a longitudinally outermost extent, and wherein the tube end portion longitudinally extends from before the longitudinally innermost extent of the surface groove to beyond the longitudinally outermost extent of the surface groove.

11. The method of claim 10, wherein the surface groove is an annular groove substantially coaxially aligned with the longitudinal axis.

12. The method of claim 1 1, wherein step e) applies a force to relatively radially move the tube end portion deformingly against the member.

13. The method of claim 12, wherein the tube end portion is in direct contact with the member.

14. The method of claim 13, wherein the tube end portion is in indirect contact with the member, and wherein the joining material is chosen from the group consisting of a weld-filler joining material and a braze joining material.

15. The method of claim 12, wherein the surface groove has a substantially rectangular cross section.

16. A method for joining a tube to a member comprising the steps of:
a) obtaining a tube;
b) obtaining a member having a surface groove;
c) after steps a) and b), relatively disposing the tube with respect to the member to completely cover the surface groove of the member without the tube entering the surface groove, wherein the tube is in at least one of a direct contact with the member and an indirect contact with the member through an intervening joining material;
d) after step c), creating a resistance welding/brazing current path through the tube and the member creating a weld/braze zone which includes at least some of the tube and at least some of the member and which fills in at least some of the surface groove; and
e) during step d), applying a force to relatively move the tube deformingly against the member,
wherein the tube is chosen from the group consisting of a damper tube of a vehicle damper and a dust cover of a vehicle damper, and wherein the member is chosen from the group consisting of a damper mounting bracket of a vehicle damper and a monolithic damper base cup and mounting bracket of a vehicle damper.

17. The method of claim 16, wherein the surface groove has a substantially rectangular cross section.

18. A method for joining a tube to a member comprising the steps of:
a) obtaining a tube having a surface groove;
b) obtaining a member;
c) after steps a) and b), relatively disposing the member with respect to the tube to completely cover the surface groove of the tube without the member entering the surface groove, wherein the member is in at least one of a direct contact with the tube and an indirect contact with the tube through an intervening joining material;
d) after step c), creating a resistance welding/brazing current path through the tube and the member creating a weld/braze zone which includes at least some of the tube and at least some of the member and which fills in at least some of the surface groove; and
e) during step d), applying a force to relatively move the tube deformingly against the member.

19. The method of claim 18, wherein the member is a non-tubular member.

20. The method of claim 19, wherein the surface groove has a substantially rectangular cross section.
